(19) United States
(12) Patent Application Publication
(10) Pub. No.: US 2002/0112020 A1
(43) Pub. Date: Aug. 15, 2002

(54) Archive of a website

(76) Inventor: Clay Harvey Fisher, Belmont, CA (US)

Correspondence Address: Maria McCormack Sobrino, BLAKELY, SOKOLOFF, TAYLOR & ZAFMAN LLP, 12400 Wilshire Boulevard 7th Floor, Los Angeles, CA, 90025, US

(21) Appl. No.: 09/735,575

(22) Filed: Dec. 12, 2000

Related U.S. Application Data
(60) Provisional application No. 60/181,836, filed on Feb. 11, 2000.

(51) Int. Cl. G06F 15/16

(52) U.S. Cl. 709/215; 709/229

(57) ABSTRACT

A computerized method, comprising constructing one or more websites; providing archive software on a computer comprising: one or more methods of website data selection; archiving selected website data to a storage medium.

### RELATED APPLICATIONS

This application claims the benefit of U.S. Provisional Application No. 60/181,836, filed Feb. 11, 2000.

### FIELD OF THE INVENTION

This invention relates generally to computers, and more particularly to a system for archiving visual files located at a website along with website characteristics.

### COPYRIGHT NOTICE/PERMISSION

A portion of the disclosure of this patent document may contain material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 1999, Sony Electronics, Inc., All Rights Reserved.

### BACKGROUND OF THE INVENTION

Presentation software exists that allows a computer to display one or more visual files such as photographs. Such presentation software may reside on a client's computer or on a server networked to the client. In addition, software in HTML format exists where one or visual files can be displayed on one or more web pages at a web site. Hyper links may exist within the website that connect to other websites. Constructed within each web site are the website characteristics; such as page templates, editing tools, banners and other site features. Along with this, the web site construction can contain business data, items such as pricing, individual client account data, and order history. Archiving or copying selected visual files is accomplished through the photograph viewing software, through the operating system file manager, or through standard HTML commands. In addition, standard HTML commands can copy an entire website. The website copy would include the page template, all other site features such as visual files, and account data that is visible on the web page.

### SUMMARY OF THE INVENTION

An archival system creates an archive copy of selected visual files, along with all or a portion of a website, and server released hidden business data, onto a machine-readable storage medium. The archived copy, when viewed, behaves in appearance and function as does the original website to the degree the original website characteristics and visual files were copied. The archived visual files and website data may be stored on any read-write medium such as a floppy disk, a hard disk drive, DVD, CD ROM, tape, or other media. In addition, the archiving of selected data may be set to an automatic schedule.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a flow diagram illustration of a website archival system;

FIG. 2 is a diagram illustrating an overview of software suitable for practicing the archival system;

FIG. 3 is an illustration of the archival system operating to linked websites;

FIG. 4a is a flow diagram of a client interacting with a server; and

FIG. 4b is a flow diagram of processing elements of a typical computer.

### DETAILED DESCRIPTION OF THE INVENTION

In the following detailed description of embodiments of the invention, reference is made to the accompanying illustrations in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

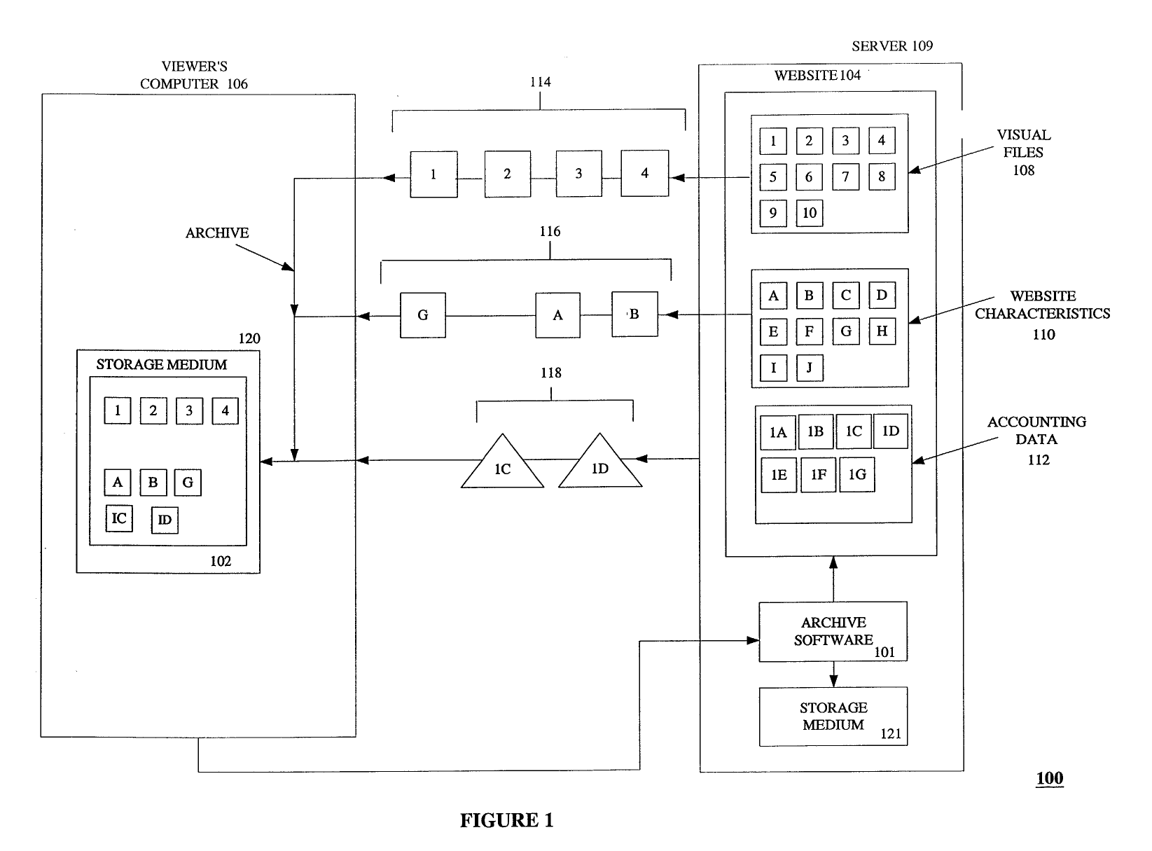

As illustrated in a flow diagram in FIG. 1, the present invention provides an archival system 100 using archive software 101 to select an entire website 104 or select a portion of the website 104 for copy to a storage medium 120, 121. The storage medium 120, 121 may reside at a viewer's computer 106 or may reside on a server 109. The viewer may be a client who will be charged a fee for some or all of the information copied. The viewer may also be the general public and some or all of the information may be available at no cost. In either case, some of the website 104 information may be protected requiring a password. Once the data to be archived is selected 114, 116, 118, copying of the data 114, 116, 118 may be performed to the storage medium 120 on the viewer's computer 106 and/or to the storage medium 121 on the server 109.

The flow diagram illustrates the viewer's computer 106 arriving at an original or first website 104. Archive software 101, accessible from the website 104 allows for selection of data for archive. A selection is made from the website data 108, 110, 112 that may include some or all of any visual files 108, some or all of the website characteristics 110, and certain accounting information (business data) 112. In addition, as described in more detail below, selection of data from websites linked to the original website 104 is possible.

Once selected, the visual files 114, website characteristics 116, and accounting information 118 are copied onto the machine-readable medium 120 or 121. When archived onto the viewer's machine-readable medium 120, the archived copy 102 may be viewed offline with the same appearance and characteristics as the original website 104 limited only by the data 114, 116, 118 that was selected for archive. Alternatively, if stored on the server machine-readable medium 121, the archived copy 102 may be accessed on-line.

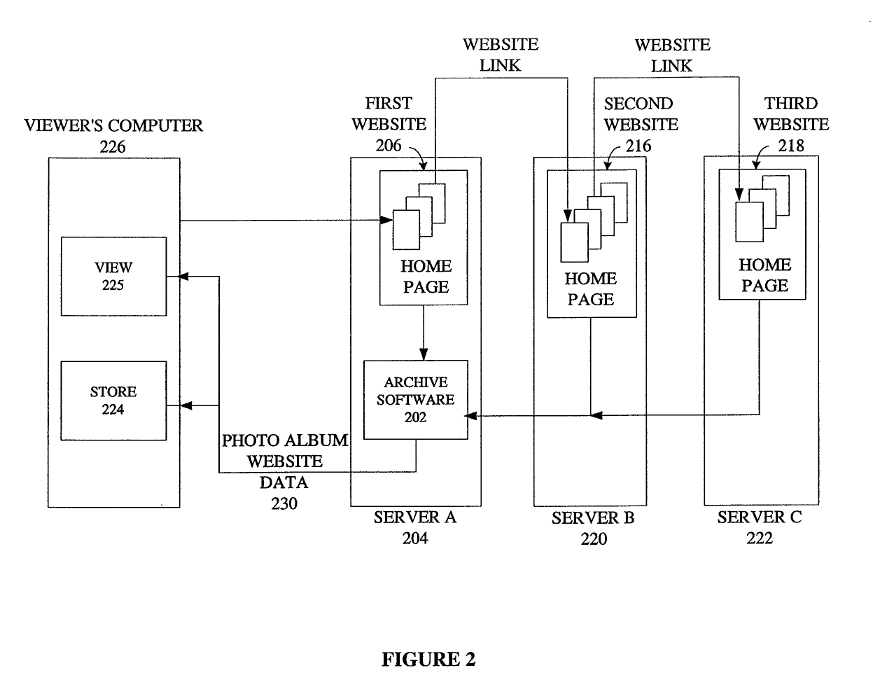

In an embodiment, a web page that behaves as a photo album to store a number of photo images is archived. Referring to FIG. 2, a flow diagram shows archive software 202 residing at a Server A 204 with Server A 204 supporting a first website 206. The archive software 202 provides for the selection of viewable files, web site characteristics, and business data from the original website 204 as well as from websites 216, 218 at server B 220 and at server C 222 linked to website 218. Alternatively, the third website 218 may be linked to the second website 216. The discussion of two linked websites 216 and 218 are illustrative only and any number of links is possible. The photo album (website data) 230, once selected, can be copied to the storage medium 224 for viewing or the photo album 230 may also be copied to server A 204 for viewing on-line or across a local network (not shown). The photo album archive copy 230 can respond similar to the original or first website 206 and display photographs at various copied links 206, 216, 218 or the photo album archive copy 230 may have all photos from all links 206, 216, 218 placed on a single photo album archive website.

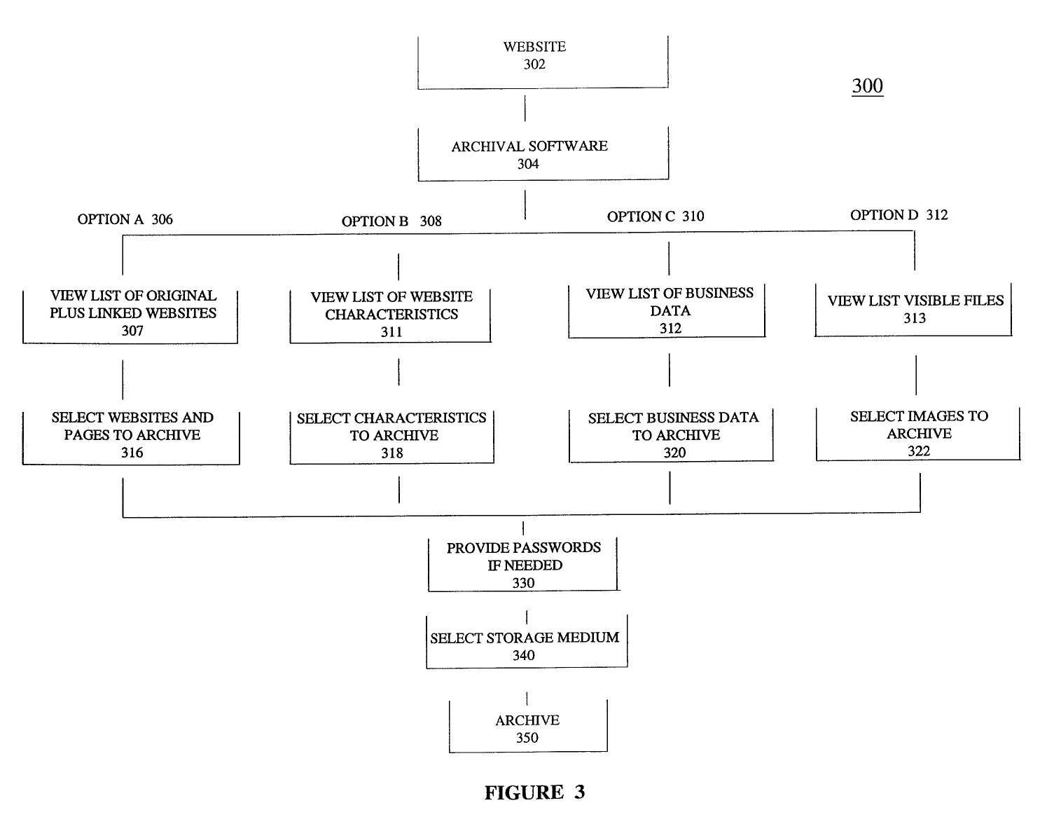

In an embodiment, the archival system 300 begins at the original website 302. Referring to FIG. 3, in one embodiment, the archive software 304 at a website 302, provides a series of options. The first option (Option A) 306 may be to view a list 307 of all websites, the original website and all websites linked to the original website. The website listing 307 may include all of the pages stacked behind each homepage of each website. At this point, portions or all of the websites listed 307 may be selected 316. The selection 316 may be made by selecting a website where the selection will automatically select all stacked pages. The selection 316 may also be made by individually selecting web pages listed under each website. In this way, the selection of web pages to any depth of links can be accomplished. Option A 306 may be ignored and the default could be that all websites, original and linked pages, are selected 316. Other variations are possible such as the default setting would select the entire original website but only the homepages of the linked websites.

A second option (Option B) 308 may provide a list 311 of all website characteristics such as; boarders, page templates, editing tools, banners, and other site features. For a default condition, all website characteristics at all web pages selected with Option A 306 could be selected 318 for archive. However, the archive software can allow the selection 318 of website characteristics by function to be specified. Selection 318 by function could archive only the website characteristics performing that function. Again, this selection 318 would be made only on the web pages selected with Option A. In this manner, the selected 318 website characteristic function(s) existing at all (selected) websites, can be archived. As described, Option B 308 allows selection 318 of website characteristics to be accomplished in several ways. The default could automatically include all website characteristics of each web page at each website (selected in Option A 306) in the selection 318. Another selection method could allow selection of website characteristics 318 individually such as: page templates, editing tools, and site features from each website or each web page at each website. Again, website characteristics considered for selection 318 in this second option will only apply to the websites and pages selected at the first option.

The archival system may then provide a third option (Option C) 310, the selection of business data. A list may be provided 312 of business data functions. Business data to be selected 320 may be chosen by the business data function. For instance, if order history and account status functions are chosen then only order history and account status information is selected from all previously selected websites (Option A 306). This functional approach can allow for the selection 320 of specific business data from any page at any website that was made available with the Option A 306. Option C 310 may also allow for a more individualized predetermination of what types of business data are to be selected 320. For example, a selection could be made of all business data 320 at the original website and only business data having a chosen function is selected 320 at the linked websites (again for websites that were made available with Option A 306). In another example, data could be selected 312 for archive in a variety of ways in which the selection criteria varies with the website. Option C 310 could allow for visiting each website and individually selecting 320 each business option available or Option C 310 could allow for a single click to select 320 all available business options from all selected websites.

Some business data, especially data visible at a website, could be copied without server restrictions. This might include data such as pricing and availability of an item. However, there may be some business data that is not visible at a website. Non-visible (hidden) data might include such data as specific viewer account data and credit information. For this hidden data, the server at each website could control what hidden data is available to what viewers and what hidden data is available through a security system such as with password protection software. When business data is selected 320, either by function, by individual selection at each website, or by requesting all business data, the archival system may prompt the viewer for a password for each website where information selected is protected.

Alternatively, Option C 310 could provide a list 312 of available business data for all viewers and a list of available business data that is protected. Selection can still be made 320 by function, by choosing each piece of business data individually, or by choosing “all” business data.

A fourth option (Option D) 312 could provide a list of all visual files 313 and the selection of certain visual files 322 for archive from the selected website(s). The list 313 could provide information as to file types. Selection of visual files 322 may be done individually from the list 313 but could also be accomplished by designating a file type. When a file type is designated such as a Bmp or Gif file, all files of that type are automatically selected for the websites selected (Option A 306). As with Option C 310, selection 322 of certain visual files may require a password 330 and the password may be associated with a billing mechanism.

Once the selection of the data (information) to be archived is accomplished, a storage medium can be designated 340. The storage medium may exist on the viewer's computer or on a server. After selection of the storage medium 340, the archive copying process 350 may be started by a mouse click on a screen location. Alternatively, the data may be pre-selected and archived automatically and periodically from a set schedule, the scheduler may also be part of the archive software. If copied from a set schedule, the archived data may be stored at the server for later transfer.

The archived data may be stored on any machine-readable media such as CD ROM, DVD, hard disk drive, floppy disk, tape system, etc. The result of the archiving process is that the archived data can be viewed in a manner that re-displays as much of the original website(s) as was selected for copy. The display of the archived copy could include information such as; visual files, website editing tools, website characteristics, banners, business information, etc.

In an embodiment, a physical dial may be attached to the viewer's computer. Software can connect the dial with the website archive software interactively. The default setting for the dial could be the original (first) website homepage visited by the viewer and turning the dial could provide a changing display of the various local pages behind the homepage. Pushing the button in may select a displayed page and a second push could de-select the displayed page. Once selected, the page could be on a list of information to be archived. Pulling the button out could begin the archive process. The dial has several advantages over the use of conventional computer input devices such as a mouse or keyboard. The first is that the dial's use is intuitively obvious to a viewer because of the viewer's prior experience with dials that operate other devices. Secondly, the dial, interfaced to a computer, may allow a series of pages to be easily displayed and selected, in a manner ideally suited to the viewer's present need.

A system to archive a potentially large amount of website data has been disclosed. Within archive software the viewer first selects the websites and/or web pages to be considered for data selection. Next the viewer selects the data to be archived. Finally, the data is copied to a storage medium. In addition, the data may be copied at a pre-determined time in a schedule. The scheduled copy may reside at the server until the viewer returns to the website and requests the data. The selected data may include business data visible on the web pages and may include hidden business data. A viewer may select in an almost endless variety of ways; the visual files, business data, and website characteristics to archive.

The selection process may first determine the websites and the web pages considered for data (information) selection. Next the viewer may select website characteristics, business data, and visual files. The data may be selected individually or with a variety of convenient methods for the websites selected. Once the selection process is complete, a single click can archive the data. Some of the data, such as the visual files or the business data, may be purchased on-line using standard methods for accounting over the Internet. Some of the data may be protected or secure, requiring a password to archive. In an embodiment, one option of the archive software provides a list of all websites and all website pages linked to the original website. The viewer is then queried through one of several selection methods to select the number and depth of websites to be considered for archiving data. The second option can provide a list of all website characteristics used in the original website construction as well as for all linked websites. The viewer then selects website characteristics to archive from a variety of selection methods available. Website characteristics can include business data that is visible to the viewer at a website location. The third option can provide the viewer with a list of business data. This list can include visible business data or it can only include hidden business data. Selection is made for the business data desired from one of several selection methods. The fourth option can provide the viewer with a list of all visual files available for archive. The visual files can include all formats of photographic, art, video, and text files. Again, several methods of selection can be provided. Selection of visual files and/or business data may require a password. Additionally, some data may be purchased using standard methods for business transactions over the Internet or a server. Included in the archive copy may be information taken from other storage mediums, as opposed to a website, such as a photograph residing on a disk. Finally, it is to be understood that the order of operation described beginning with Option A and proceeding sequentially through Option D is described for convenience only. There is no implied or required order of operation for using the listed options. Further, this invention is not limited to four options, additional options that perform other functions are possible and can be added to those listed above. Such other options could include a variety of operations such as sending copies of the archive data across the Internet to selected e-mail addresses or placing the business data in a spreadsheet.

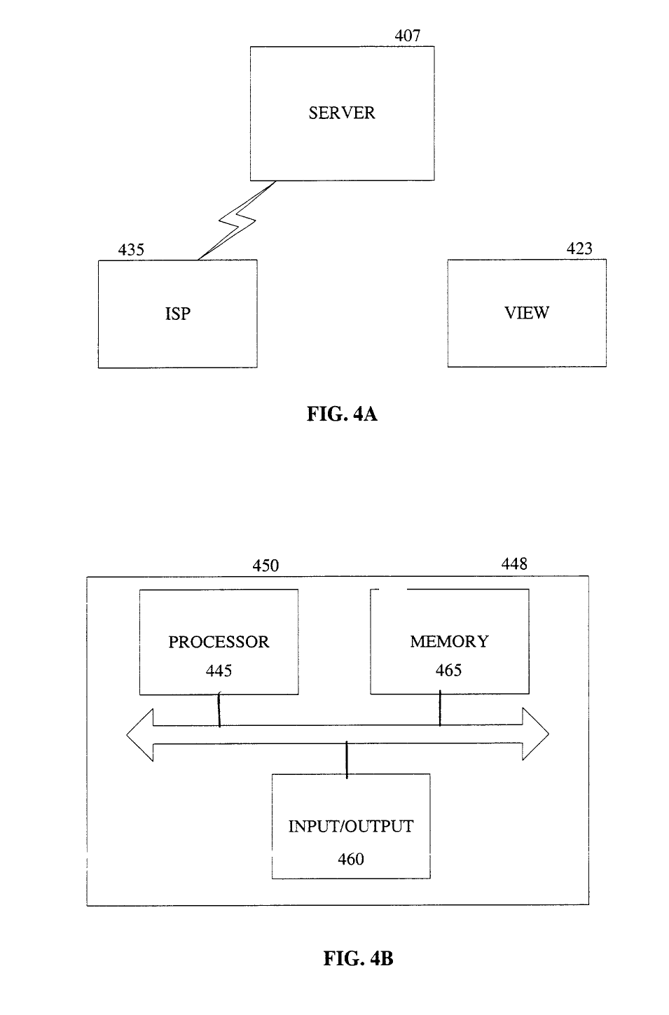

One embodiment of a computer system suitable for use as a website archive system is a server computer 401 as illustrated in FIGS. 4a and 4b. The computer system 440 includes a processor 450, memory 455 and input/output capability 460 coupled to a system bus 465. The memory 455 is configured to store instructions which, when executed by the processor 450, perform the methods described herein. The memory 455 may also store data and content related to websites. Input/output 460 provides for the delivery and display of the content of the website or portions or representations thereof. Input/output 460 also encompasses various types of computer-readable media, including any type of storage device that is accessible by the processor 450. One of skill in the art will immediately recognize that the term “computer-readable medium/media” further encompasses a carrier wave that encodes a data signal. It will also be appreciated that the server 401 is controlled by operating system software executing in memory 455. Input/output and related media 460 store the computer-executable instructions for the operating system and methods of the present invention as well as the data and content related to the websites.

The description of FIGS. 4a & b is intended to provide an overview of computer hardware and other operating components suitable for implementing the invention, but it is not intended to limit the applicable environments. It will be appreciated that the computer system 440 is one example of many possible computer systems that have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention.

For example, those of ordinary skill within the art will appreciate that where the invention as been described in terms of creating an archive copy of visual files that the visual files encompass all types of visual data, including pure text, illustrated text, the combination of audio and video, and audio only.

The terminology used in this application with respect to networks is meant to include all of environments in which a server computer communicates with client computers to send and receive data. Therefore, it is manifestly intended that this invention be limited only by the following claims and equivalents thereof.

What is claimed is:

1. A computerized method, comprising:
constructing one or more websites;
providing archive software on a computer comprising:
one or more methods of website data selection;
archiving selected website data to a storage medium.

2. The method of claim 1, wherein the computer is a server.

3. The method of claim 1, wherein the selected website data comprises one or more visual files.

4. The method of claim 1, wherein the selected website data comprises one or more website characteristics.

5. The method of claim 1, wherein the selected website data comprises one or more types of business data.

6. The method of claim 1, wherein at least one of the one or more types of business data is hidden business data.

7. The computerized method of claim 3, wherein the one or more visual files are of a type chosen from a group consisting of video, photographs, text, and artwork.

8. The computerized method of claim 4, wherein the one or more website characteristics are chosen from a group consisting of: order history, banners, page templates, editing tools, and site features.

9. The computerized method of claim 5, wherein the one or more types of business data are chosen from the group consisting of: user account data, order history, credit history, inventory, camera settings, and photographer.

10. The computerized method of claim 1, wherein a button on a computer is interactive with archiving selected website data.

11. The computerized method of claim 10, wherein archiving selected website data is accomplished automatically to a set schedule.

12. The computerized method of claim 1, wherein a dial is interactive with selecting the website data.

13. A computerized method, comprising:
constructing a website having information, comprising:
archive software,
one or more photographs,
one or more website characteristics, and
one or more types of business data;
copying a selection of the website information to a storage medium.

14. The computerized method of claim 13, further comprising:
copying a selection of information to a storage medium from more than one website.

15. The computerized method of claim 13, wherein a dial is interactive with the selection of website information.

16. A computerized method, comprising:
constructing a website having information, comprising:
archive software,
one or more visual files,
one or more website characteristics, and
one or more types of business data, comprising:
visible business data, and
hidden business data;
archiving selected information at the website to a storage medium; and
archiving selected information at a non-website to the storage medium.

17. The computerized method of claim 16, further comprising:
archiving selected information located at one or more websites.

18. The computerized method of claim 11, wherein archiving selected information is interactive with a dial.

19. A computerized method, comprising:
placing archive software on a user's computer;
constructing at least one website, comprising:
visual files,
web page characteristics,
business data; and
archiving selected data from one or more of the at least one web site to a storage medium.

20. The computerized method of claim 19, wherein the archiving is interactive with a dial.

21. The computerized method of claim 19, wherein archiving is automatically initiated to a pre-set schedule.

22. A computerized system, comprising:
a server, comprising:
a website, comprising:
one or more web pages controlled by the server, comprising:
web page characteristics,
business data, and
visual files,
archive software;
a remote computer having a storage medium, receiving from the server the archive software to archive copies of the web page characteristics, the business data, and the visual files to the storage medium.

23. The computerized system of claim 22, wherein the archive software further comprises:
security software to restrict data that can be archived by the remote computer.

24. The computerized system of claim 22, wherein the website further comprises links to other websites.

25. The computerized system of claim 22, wherein the archive software allows copy to the storage medium of web page characteristics, business data, and visual files from the linked websites.

26. A computerized method, comprising:
constructing one or more websites with one or more servers;
providing archive software on at least one of the one or more websites;
archiving all website information, made available by the one or more servers to a storage medium.

27. The computerized method of claim 26, wherein the archival software further comprises:
security software to limit the website information available for archiving.

28. A computerized method, comprising:
constructing one or more websites, comprising:
archive software on at least one of the one or more websites,
visual files,
website characteristics, and
business data;
providing password protection on at least one of the one or more websites; and
providing banners on at least one of the one or more websites.

29. The method of claim 28, further comprising:
constructing in at least one of the one or more websites, software to allow for business transactions over the Internet.

30. The method of claim 26, wherein the archive software allows for a depth of linked websites to be specified for selection.

31. A computer-readable medium having computer-executable instructions to cause a computer to perform a method comprising:
operating one or more servers;
providing website information by the one or more servers, comprising:
archive software, and
security software,
banners; and
archiving a selection of website information to a machine-readable medium.

32. The method of claim 31, further comprising:
purchasing a portion of the website information.

33. A networked server system comprising:
one or more websites;
at least one archive software on the one or more websites;
one or more servers operating the one or more websites;
website information, comprising:
business data on at least one of the one or more websites;
hidden business data on at least one of the one or more websites;
one or more visual files on at least one of the one or more websites;
one or more website characteristics on at least one of the one or more websites;
one or more a machine readable storage mediums;
one or more banners residing on at least one of the one or more websites; wherein the archive software is interactive with the one or more websites for archiving website information.

34. The networked server system of claim 33, wherein the archive software includes a password protection for the website information.

35. The networked server system of claim 33, wherein the website information includes billing information.
